(19) United States
(12) Patent Application Publication
(10) Pub. No.: US 2006/0184906 A1
(43) Pub. Date: Aug. 17, 2006

(54) Method and device for designing semiconductor integrated circuit

(75) Inventor: Toshio Aizawa, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/353,073

(22) Filed: Feb. 14, 2006

(30) Foreign Application Priority Data
Feb. 15, 2005 (JP) 2005-038468

(51) Int. Cl. G06F 17/50

(52) U.S. Cl. 716/6; 716/10

(57) ABSTRACT

A method for designing a semiconductor integrated circuit includes steps of (a) to (e). The step (a) is a step of placing a plurality of elements based on circuit data including data of the plurality of elements to be placed on a semiconductor integrated circuit. The step (b) is a step of estimating a position of an interconnection branching node at which an interconnection branches off to each of the plurality of elements. The step (c) is a step of estimating each interconnection length between the interconnection branching node and each of the plurality of elements. The step (d) is a step of calculating a delay timing variation based on the each interconnection length, wherein the delay timing variation is a variation of an arrival time when a signal travels from the interconnection branching node to each of the plurality of elements. The step (e) is a step of verifying whether the delay timing variation is within a design allowable range of the semiconductor integrated circuit.

### BACKGROUND OF THE INVENTION

1. Field of the Invention

The present invention relates to a method and device for designing a semiconductor integrated circuit. More particularly, the present invention relates to a method and device for designing a semiconductor integrated circuit that can improve design efficiency of the semiconductor integrated circuit.

2. Description of the Related Art

Currently, as increasing a scale of a semiconductor integrated circuit and a miniaturization in a process, a proportion of an interconnection delay to a circuit delay has been increasing. Variations of the interconnection delay value (delay time) are generated among interconnections with the same length, due to such factors as different interconnection widths caused by manufacturing variations, and different densities of impurity incorporation. Therefore, it is an indispensable technique to take the variations of the interconnection delay value into consideration in performing a timing verification of a semiconductor circuit.

When the timing verification of the semiconductor circuit is performed after detailed routing, a length of each interconnection is accurately determined. Therefore, variations of the interconnection delay value can be taken into consideration for each interconnection. However, when the timing verification is performed prior to the detailed routing, variations of the interconnection delay value are defined as a uniform margin.

Techniques shown below have been proposed in relation to the technique mentioned above.

Japanese Laid Open Patent Application (JP-P2002-318829 A) discloses a circuit simulation method, a circuit simulation apparatus, a circuit simulation program and a computer-readable record medium recording the program. This circuit simulation method is for a semiconductor device of which a circuit configuration is specified by a netlist. The circuit simulation method includes processing to perform mathematization of variations that correspond to a layout pattern and placement of elements used in the semiconductor device, into a mathematical expression that includes parameters; processing to organize the parameters included in the mathematical expression into an element parameter group that corresponds to each element, to store the element parameter group in a memory means; processing to make the parameters in the element parameter group vary by using a condition obtained from manufacturing process variations of the semiconductor device; and processing to conduct a circuit simulation by an arithmetic processing means with the use of the varied parameters.

Also, Japanese Laid Open Patent Application (JP-P2001-265826 A) discloses a circuit simulation method and apparatus. This circuit simulation method performs a delay analysis of an interconnection including dimension variations from a design value generated in manufacturing. The circuit simulation method has a step of searching a target interconnection structure having a target interconnection and a target adjacent interconnection adjacent to the target interconnection, to which the delay analysis is performed, from layout information; a step of calculating an interconnection resistance in at least each interconnection width variations of the target interconnection; a step of obtaining a reference interconnection structure similar to the target interconnection structure for a reference interconnection structure showing position relationship between a reference interconnection per length and a reference adjacent interconnection adjacent to the reference interconnection, from capacitance model information that preliminarily stores an interconnection capacitance of the reference interconnection in each reference interconnection structure for the reference interconnection of a plurality of widths at least, and calculating an interconnection capacitance of the target interconnection from an interconnection capacitance of the reference interconnection of the obtained reference interconnection structure in at least each dimension variations of the interconnection width of the target interconnection and the target adjacent interconnection; and a step of performing the delay analysis of the target interconnection by using the interconnection resistance and interconnection capacitance in each dimension variations of the target interconnection.

Also, Japanese Laid Open Patent Application (JP-P2002-313916 A) discloses a layout design device and a layout design method of semiconductor integrated circuit. This layout design device of a semiconductor integrated circuit includes a layout means to perform placement and routing of each circuit element based on logical connection information of a semiconductor integrated circuit that is to be designed; a delay analysis means to perform delay analysis processing for a layout obtained by the layout means; a buffer inserting means to insert a repeater buffer to an interconnection that connects circuit elements such that a delay characteristic is improved when a desired delay characteristic cannot be obtained between the circuit elements as a result of the delay analysis processing; a buffer moving means to move the repeater buffer when another circuit block is present in an insertion position of the repeater buffer; and a buffer changing means to change electrical properties of the repeater buffer or elements in the circuit such that the delay characteristic is improved when a desired delay characteristic cannot be obtained between the circuit elements after performing the delay analysis processing for a layout obtained by moving the repeater buffer.

Also, Japanese Laid Open Patent Application (JP-P2003-337844 A) discloses a delay adjustment method and a delay value calculation method. This delay adjustment method adjusts a delay caused in paths in a semiconductor integrated circuit by using a delay adjustment cell. The delay adjustment method has a first step of obtaining a delay value and a skew before the delay adjustment for each of a plurality of process conditions of the semiconductor integrated circuit, based on layout information; a second step of obtaining an estimated delay value and an estimated skew under a predetermined process condition in a case that a delay caused in the paths is adjusted such that a skew under a reference process condition is reduced based on a delay value and a skew before the delay adjustment under the reference process condition, when a circuit operation cannot be secured with the delay value and skew before the delay adjustment obtained in the first step under the predetermined process condition; and a third step of adjusting a delay caused in the paths by using the delay adjustment cell when the circuit operation can be secured with the estimated delay value or estimated skew under the predetermined process condition obtained in the second step.

Also, Japanese Laid Open Patent Application (JP-P2004-246557 A) discloses an examination method and a layout method of semiconductor integrated circuit. This examination method of a semiconductor integrated circuit estimates a point where a drop of a supply voltage in the circuit is likely to be caused, from switching time variations of a transistor provided to the semiconductor integrated circuit.

In the conventional technique, when the timing verification is performed after the detailed routing, there is a problem of an increase in design period following a change in design of the placement and routing due to a necessity to correct the placement and routing when timing violation is found, even though delay value variations caused by interconnection variations can accurately be taken into consideration. When the timing verification is performed before the detailed routing, accuracy of a uniform margin value defined as the delay value variations is a problem. When the uniform margin value is larger than the delay value variations in an actual circuit after the element placement, it is necessary to perform design again in order to curb a delay in the actual circuit. As a result, a problem of an increase in the design period and circuit scale is caused. On the other hand, when the uniform margin value is smaller than the delay value variations in the actual circuit after the element placement, it is also necessary to perform design again since the circuit does not operate properly because of delay violation generated in the actual circuit. Consequently, the problem of the increase in the design period is caused.

For example, in the layout design device and layout design method of semiconductor integrated circuit disclosed in Japanese Laid Open Patent Application (JP-P2002-313916 A), the timing verification is performed after detailed routing. If the timing violation is found, it is necessary to correct the placement and routing by re-performing the design. Also, in the delay adjustment method and delay value calculation method disclosed in Japanese Laid Open Patent Application (JP-P2003-337844), delay value variations show a uniform value since the delay value variations are derived from a reference process. Therefore, when the timing verification is performed after the detailed routing, the delay value variation caused by the interconnection variation can accurately be taken into consideration. If the timing violation is found however, there is a problem of the increase in the design period following a change in the design of the placement and routing. This is because it becomes necessary to correct the placement and routing. On the other hand, when the timing verification is performed before the detailed routing, there is a problem of accuracy of a uniform margin value defined as the delay value variation.

### SUMMARY OF THE INVENTION

In order to achieve an aspect of the present invention, the present invention provides a method for designing a semiconductor integrated circuit including: (a) placing a plurality of elements based on circuit data including data of the plurality of elements to be placed on a semiconductor integrated circuit; (b) estimating a position of an interconnection branching node at which an interconnection branches off to each of the plurality of elements; (c) estimating each interconnection length between the interconnection branching node and each of the plurality of elements; (d) calculating a delay timing variation based on the each interconnection length, wherein the delay timing variation is a variation of an arrival time when a signal travels from the interconnection branching node to each of the plurality of elements; and (e) verifying whether the delay timing variation is within a design allowable range of the semiconductor integrated circuit.

In the present invention, the interconnection length between the interconnection branching node and each of the plurality of elements can be accurately estimated based on the accurately estimated interconnection branching node. Therefore, the delay timing variation can be correctly estimated, even before the interconnection design is performed. Thus, as the verification of the delay timing variation can be preliminarily performed before the interconnection design is performed, it is possible to avoid re-performing element placement after interconnection design is performed.

### BRIEF DESCRIPTION OF THE DRAWINGS

The above and other objects, advantages and features of the present invention will be more apparent from the following description taken in conjunction with the accompanying drawings, in which:

FIG. 1 is a schematic view showing relative positions among a plurality of target elements and an interconnection branching node estimated by a method for designing a semiconductor integrated circuit in the first embodiment of the present invention;

FIG. 2 is a flowchart showing the method for designing a semiconductor integrated circuit in the first embodiment of the present invention;

FIG. 3 is a schematic circuit diagram showing an example to which an actual timing verification is applied;

FIG. 4 is a schematic view showing relative positions among a plurality of target elements and an interconnection branching node estimated by a method for designing a semiconductor integrated circuit in the second embodiment of the present invention;

FIG. 5 is a schematic view showing an example of a layout of interconnections among the plurality of target elements and the estimated interconnection branching node in the second embodiment of the present invention;

FIG. 6 is a schematic view showing relative positions among a plurality of target elements and interconnections in the third embodiment of the present invention;

FIG. 7 is a schematic view showing relative positions among a plurality of target elements and interconnection branching nodes estimated by the method for designing a semiconductor integrated circuit in the third embodiment of the present invention;

FIG. 8 is a flowchart showing the method for designing a semiconductor integrated circuit in the third embodiment of the present invention;

FIG. 9 is the schematic view showing a configuration of a device for designing a semiconductor integrated circuit in the fourth embodiment of the present invention; and

FIG. 10 is a flowchart showing the method for designing a semiconductor integrated circuit in the fourth embodiment according to the present invention.

### DESCRIPTION OF THE PREFERRED EMBODIMENTS

Embodiments of a method and device for designing a semiconductor integrated circuit according to the present invention will be described below with reference to the attached drawings.

In the method and device for designing a semiconductor integrated circuit according to the present invention, an interconnection branching node is estimated in a design process of the semiconductor integrated circuit before detailed interconnection design is performed. The interconnection branching node is a point where an interconnection, which is for transmitting a signal to a plurality of target elements that are placed, branches off to each of the plurality of target elements. Then, a length of an interconnection from the estimated interconnection branching node to each of the plurality of target elements is calculated. After that, delay timing variation, which is a variation of an arrival time when the signal travels from the interconnection branching node to each of the plurality of target elements, are obtained based on the calculation result. Here, the variation is, for example, the difference between a maximum value and a minimum value.

By verifying whether the delay timing variations are within a design allowable range of the semiconductor integrated circuit, it is possible to avoid re-performing the design that is required after performing the detailed interconnection design. As a result, it is realized to improve the design efficiency of the semiconductor integrated circuit.

### First Embodiment

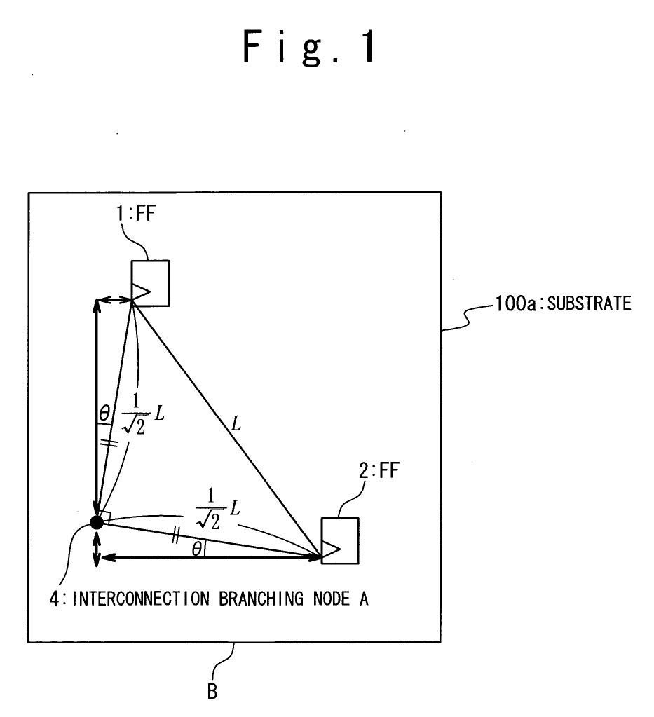

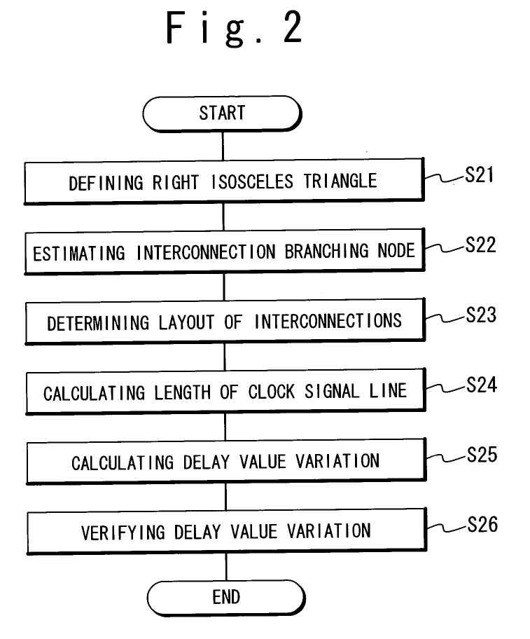

FIG. 1 is a schematic view showing relative positions among a plurality of target elements and an interconnection branching node estimated by a method for designing a semiconductor integrated circuit in the first embodiment of the present invention. In this embodiment, a register: FF (Flip-Flop) 1 and a register: FF 2, which are synchronous circuits placed on a substrate 10a, are elements to which delay timing analysis is performed. FIG. 2 is a flowchart showing the method for designing a semiconductor integrated circuit in the first embodiment of the present invention.

In this embodiment, a right isosceles triangle of which hypotenuse is a line segment connecting the FF 1 and the FF 2, is defined by the FF 1 and the FF 2 (step S21). Here, the FF 1 and the FF 2 are the synchronous circuits and the subjects of the delay timing analysis. Then, it is estimated that a position of an apex of the right isosceles triangle is a position of an interconnection branching node A 4 of the FF 1 and the FF 2 (step S22). When routing of a clock signal line is executed from a clock signal source (not shown) to each of the FF 1 and the FF 2 on the substrate 10a of the semiconductor integrated circuit, a layout of the interconnections is generally determined by using straight lines that are at right angles to each other (step S23).

In this embodiment, it is assumed that a length of the line segment connecting the FF 1 and the FF 2 in FIG. 1 is L, an angle between a vertical line passing through the interconnection branching node A 4 and a line segment connecting the FF 1 and the interconnection branching node A 4 is θ, and an angle between a parallel line passing through the FF 2 and a line segment connecting the FF 2 and the interconnection branching node A 4 is θ. Here, the vertical line is vertical to a base line B of the substrate 100a shown in FIG. 1. The parallel line is parallel to the base line B. The length of the signal line from the estimated position of the interconnection branching node A 4 to each of the FF 1 and the FF 2 is expressed as follows: sin θ×(L/2^{0.5})+cos θ×(L/2 ^{0.5}). In this mathematical expression, “×” is used as a multiple mark.

In this embodiment as stated above, the length of the clock signal line from the estimated position of the interconnection branching node A 4 to each of the FF 1 and the FF 2 is obtained (step S24) Then, a delay value variation of a clock signal generated in an actual signal line is calculated with the obtained length of the clock signal line as explained below (step S25). After that, the delay value variation is verified whether or not to be within a design allowable range of the semiconductor integrated circuit as described later (step S26). Consequently, it is possible to avoid re-performing the interconnection design after the interconnection design is already performed.

To calculate a delay value variation that corresponds to the length of the signal line from the estimated position of the interconnection branching node A 4 to each of the FF 1 and the FF 2, it is just necessary to multiply the length by a delay value variation (α) per unit estimated interconnection length. This delay value variation (α) is set in advance, in each design condition of the semiconductor integrated circuit. Therefore, in this embodiment, the delay value variation of the clock signal is expressed as follows: α×(sin θ×(L/2^{0.5})+cos θ×(L/2^{0.5})). In this mathematical expression, “×” is used as a multiple mark.

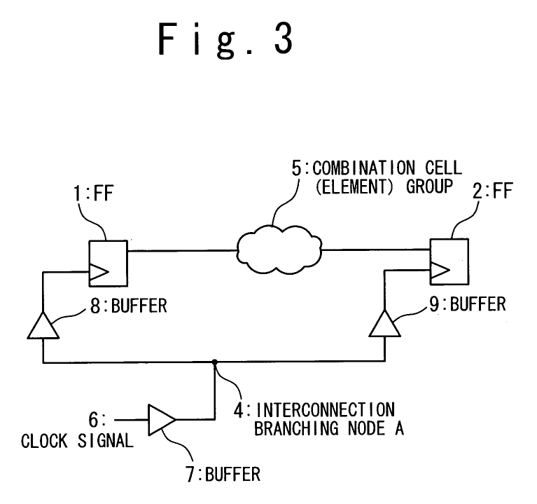

Next, a timing verification is performed to verify that the above calculated delay value variation of the clock signal is within the design allowable range of the semiconductor integrated circuit. Various methods may be used for the timing verification. Here, timing verification with a setup time and a hold time is described. FIG. 3 is a schematic circuit diagram showing an example to which an actual timing verification is applied. In FIG. 2, a buffer 7, a buffer 8, and a buffer 9 generally referred to as clock trees, are provided for the purpose of minimizing a clock skew between the FF 1 and the FF 2.

As shown in FIG. 3, in the actual timing verification, a delay amount in each element of the buffer 7 connected to a clock signal input of the interconnection branching node A 4; the buffer 8 connected to a clock signal input of the FF 1; and the buffer 9 connected to a clock signal input of the FF 2, is also taken into consideration. Further, in the timing verification with the setup time and the hold time, it is also necessary to consider a delay amount of a combination cell (element) group 5 actually placed between the FF 1 and the FF 2, and an interconnection delay of interconnections connected to the combination cell (element) group 5. Data regarding delay amounts such as the delay in each element of the buffer 7, the buffer 8, the buffer 9 and the combination cell (element) group 5 are stored in a database in advance as a delay library. The data in the database are used for the timing verification. As for the interconnection delays of the interconnections connected to the combination cell (element) group 5, a temporary interconnection delay library set in advance in each design condition of the semiconductor integrated circuit is used. The temporary interconnection delay library is stored in a database in advance as in the case of the delay library. The data in the database is used for the timing verification.

Judgement criteria of the timing verification for the FF 2 in the embodiment are shown below.

(A judgement criterion in a setup time verification)
A1+B1+C1+D1+E1<F1

A1: delay time in the elements of the FF 1, the combination cell (element) group 5 and the FF 2;

B1: delay time in temporary interconnections of the FF 1, the combination cell (element) group 5, and the FF 2;

C1: α×(sin θ×(L/2^{0.5})+cos θ×(L/2^{0.5}));

D1: setup time of the FF 2;

E1: margin other than variations of clock skew and so on; and

F1: clock cycle of the FF 2.

(A judgement criterion in hold time verification)
A1+B1−C1−E1>G1

G1: hold time of the FF 2.

The margin other than variations of clock skew and so on in the above equations is exemplified by a clock skew, which is a delay difference of a clock tree, and noise of a clock signal itself inputted from the outside to the semiconductor circuit. The delay difference of a clock tree is, in this embodiment, a difference between a delay value (delay time) of a clock signal travelling in the order of a buffer 7, a buffer 8, and the FF 1, and a delay value (delay time) of a clock signal travelling in the order of the buffer 7, a buffer 9, and the FF 2. These are delay value margins generated even without variations in a manufacturing process. Detailed explanation thereof is not given here.

When it is verified as a result of the verification based on the above judgement criteria of the setup time verification and the hold time verification, that the delay value variation of the clock signal derived in this embodiment is within the design allowable range of the semiconductor integrated circuit, the next design process is followed. However, when it is not verified, a change is made such that the relative positions of the FF 1 and the FF 2 on the substrate 10a get closer for example, based on the verification result.

According to the present invention, since the verification of clock variations among target synchronous circuits in particular is preliminarily executed before the interconnection design is performed, it is possible to avoid re-performing placement of the synchronous circuits after the interconnection design is performed. Thus, the present invention can provide the method for designing a semiconductor integrated circuit with high design efficiency.

Additionally, in the embodiment, description is given with the use of the right isosceles triangle of which hypotenuse is the line segment connecting the FF 1 and the FF 2. Alternatively, an isosceles triangle with any apex angle may also be applicable.

### Second Embodiment

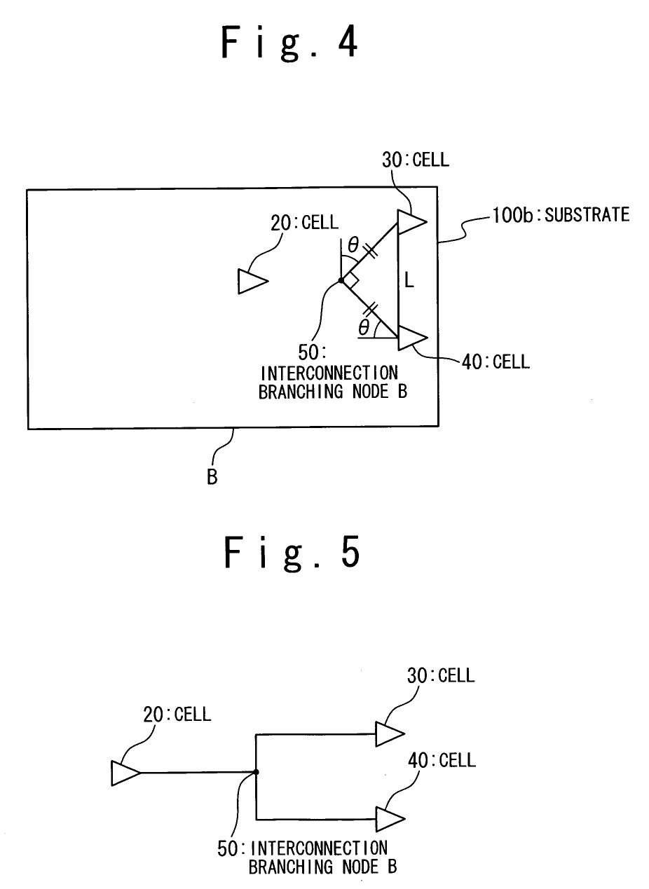

FIG. 4 is a schematic view showing relative positions among a plurality of target elements and an interconnection branching node estimated by a method for designing a semiconductor integrated circuit in the second embodiment of the present invention. A basic principle of the method for designing a semiconductor integrated circuit in this embodiment is the same as that of the first embodiment. A flowchart of the method for designing a semiconductor integrated circuit in the second embodiment is also the same as that of the first embodiment as shown in FIG. 2. However, in this embodiment, the subjects of the timing analysis are general elements, and not limited to synchronous circuits. Consequently, an interconnection that is the subject of length estimation is a data signal line transmitting a general data, and not limited to a clock signal line.

In this embodiment, a cell 30 and a cell 40 placed on a substrate 100b are elements that are the subjects of the timing analysis. Here, an interconnection branching node of an interconnection for transmitting a data signal from a cell 20, which is a data signal source, to each of the cell 30 and the cell 40, which are the subjects of the timing analysis, is estimated. Then, a timing delay value of a data signal transmitted from the estimated interconnection branching node to each of the cell 30 and the cell 40 is estimated. After that, it is judged whether or not the estimated timing delay value of the data signal is within the design allowable range of the semiconductor integrated circuit.

In this embodiment, a right isosceles triangle of which hypotenuse is a line segment connecting the cell 30 and the cell 40 is defined by the cell 30 and the cell 40 (step S21). Here, the cell 30 and the cell 40 are the subjects of the timing analysis. Then, it is estimated that a position of an apex of the right isosceles triangle is a position of an interconnection branching node B 50 of the cell 30 and the cell 40 (step S22). In the substrate 100b of the semiconductor integrated circuit, when routing of a data signal line is executed from the data signal source cell 20 to each of the cell 30 and the cell 40, an interconnection layout is generally performed by using straight lines that at right angles to each other (step S23). FIG. 5 is a schematic view showing an example of a layout of interconnections among the plurality of target elements and the estimated interconnection branching node in the second embodiment of the present invention. Therefore, in this embodiment, interconnections including a combination of orthogonal data signal lines are laid out from the data signal source cell 20 through the interconnection branching node B 50 to each of the cell 30 and the cell 40 as shown in FIG. 5.

In this embodiment, it is assumed that a length of the line segment connecting the cell 30 and the cell 40 in FIG. 3 is L, an angle between a vertical line passing through the interconnection branching node B 50 and a line segment connecting the cell 30 and the interconnection branching node B 50 is θ, and an angle between a parallel line passing through the cell 40 and the line segment connecting the cell 40 and the interconnection branching node B 50 is θ, in order to obtain a length of the data signal line from the estimated position of the interconnection branching node B 50 to each of the cell 30 and the cell 40. Here, the vertical line is vertical to a base line B of the substrate 100b shown in FIG. 3. The parallel line is parallel to the base line B. the length of the data signal line from the estimated position of the interconnection branching node B 50 to each of the cell 30 and the cell 40 is expressed as follows: sin θ×(L/2 ^{0.5})+cos θ×(L/2 ^{0.5}). In this mathematical expression, “×” is used as a multiple mark.

In this embodiment as in the case of the first embodiment, the length of the data signal line from the estimated position of the interconnection branching node B 50 to each of the cell 30 and the cell 40 is obtained (step S24). Then, a delay value variation of a signal generated in an actual data signal line is calculated with the obtained length of the data signal line (step S25). After that, and the delay value variation is verified whether or not to be within the design allowable range of the semiconductor integrated circuit (step S26). Consequently, it is possible to avoid re-performing the interconnection design after the interconnection design is already performed. The calculation of the delay value variation of the data signal in this embodiment, and the method for verifying whether or not the calculated delay value variation is within the design allowable range of the semiconductor integrated circuit in this embodiment, are the same as those of the first embodiment. Therefore, detailed explanation thereof is not given here.

When it is verified that the delay value variation of the data signal derived in this embodiment is within the design allowable range of the semiconductor integrated circuit, the next design process is followed. However, when it is not verified, a change is made such that the relative positions of the cell 30 and the cell 40 on the substrate 100b get closer for example, based on the verification result.

In this embodiment as in the case of the first embodiment, since the verification of variations of the data signal delay value in the target elements in particular is preliminarily performed before the interconnection design is performed, it is possible to avoid re-performing element placement after the interconnection design is performed. Thus, the present invention can provide the method for designing a semiconductor integrated circuit with high design efficiency.

### Third Embodiment

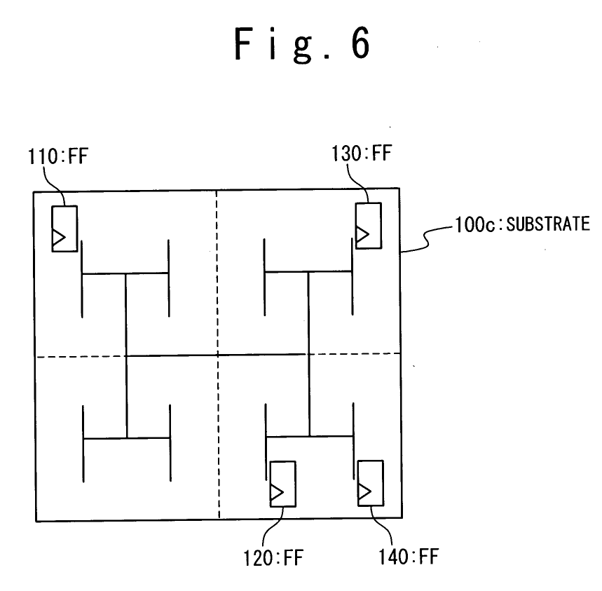

FIG. 6 is a schematic view showing relative positions among a plurality of target elements and interconnections in the third embodiment of the present invention. In a method for design a semiconductor integrated circuit in the third embodiment, a register: FF 110, a register: FF 120, a register: FF 130, and a register: FF 140, which are synchronous circuits placed on a substrate 100c, are the subjects of the timing analysis.

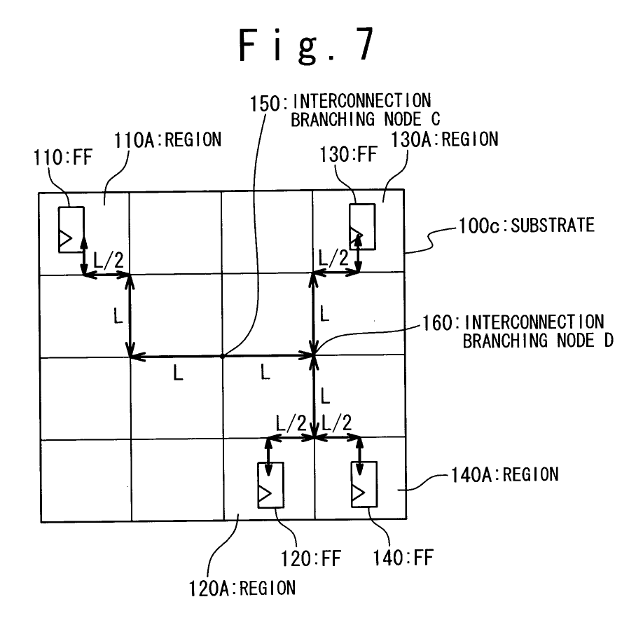

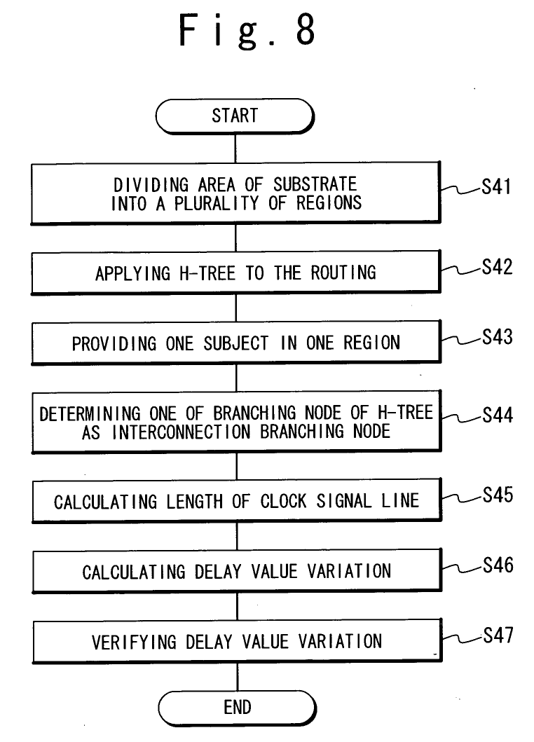

FIG. 7 is a schematic view showing relative positions among a plurality of target elements and interconnection branching nodes estimated by the method for designing a semiconductor integrated circuit in the third embodiment of the present invention. FIG. 8 is a flowchart showing the method for designing a semiconductor integrated circuit in the third embodiment of the present invention. In this embodiment, an area of the substrate 100c on which the register: FF 110, the register: FF 120, the register: FF 130, and the register: FF 140, is divided into an optimum number of a plurality of regions which are placed in lattice-like arrangement based on a clock frequency, a size and the like of the above synchronous circuits (step S41). The shape of each of the plurality of regions may be a square.

In this embodiment, a hypothetical clock tree of an H shape (H-tree) as shown in FIG. 6, is applied to the routing in order to determine interconnection branching nodes from a clock signal source (not shown) to each of the synchronous circuits (step S42). Then, it is assumed that each of the synchronous circuits, hich are the subjects of the timing analysis (the FF 110, the FF 120, the FF 130, and the FF 140), are provided in one of the regions divided as shown in FIG. 7 (step S43). That is, it is assumed that the FF 110, the FF 120, the FF 130 and the FF 140 are included in a region 110A, a region 120A, and a region 130A and a region 140A, respectively.

Here, when performing the timing analysis between the FF 110 and the FF 120 included in the region 110A and the region 120A respectively, an interconnection branching node C 150 is considered as shown in FIG. 7. The interconnection branching node C 150 is determined by selecting a point at an equal distance from each of the FF 110 and the FF 120, one of the branching node of the H-tree. Similarly, when the timing analysis is performed between the FF 130 and the FF 140 included in the region 130A and the region 140A respectively, an interconnection branching node D 160 is considered as shown in FIG. 6. The interconnection branching node D 160 is determined by selecting a point at an equal distance from each of the FF 130 and the FF 140, one of the branching node of the H-tree (step S44). When a length of a side of a lattice is L as shown in FIG. 7, a distance between the interconnection branching node C 150 estimated in the above way and each of the synchronous circuits FF 110 and FF 120 is expressed as 3L. Also, a distance between the interconnection branching node D 160 and each of the synchronous circuits FF 130 and FF 140 is obtained in the same way, and the distance is expressed as 2L (step S45). If a distance of a clock signal line between each of a plurality of synchronous circuits to be the subjects of the timing analysis and an estimated interconnection branching node can be estimated, a delay value variation of a clock signal proportional to the distance is obtained (step S46). After that, and the delay value variation is verified whether or not to be within the design allowable range of the semiconductor integrated circuit (step S47). Consequently, it is possible to avoid re-performing the interconnection design after the interconnection design is already performed. The calculation of the delay value variation of the clock signal in this embodiment, and the method for verifying whether the calculated delay value variation is within the design allowable range of the semiconductor integrated circuit, are the same as those of the first and second embodiments. Therefore, detailed description thereof is not given here.

When it is verified that the delay value variation of the clock signal derived in this embodiment is within the design allowable range of the semiconductor integrated circuit, the next design process is followed.

However, when it is not verified, a change is made such that the relative positions of the FF 110 and the FF 120 on the substrate 100c get closer for example, based on the verification result.

Additionally, in this embodiment, description is given with the use of the synchronous circuits as the subjects of the timing analysis. The subjects of the timing analysis are not limited to the synchronous circuits, and general elements may also be used.

In this embodiment as in the case of the first and second embodiments, since the verification of variations of the signal delay value in the target elements in particular is preliminarily performed before the interconnection design is performed, it is possible to avoid re-performing the element placement after the interconnection design is performed. Thus, the present invention can provide the method for designing a semiconductor integrated circuit with high design efficiency.

### Fourth Embodiment

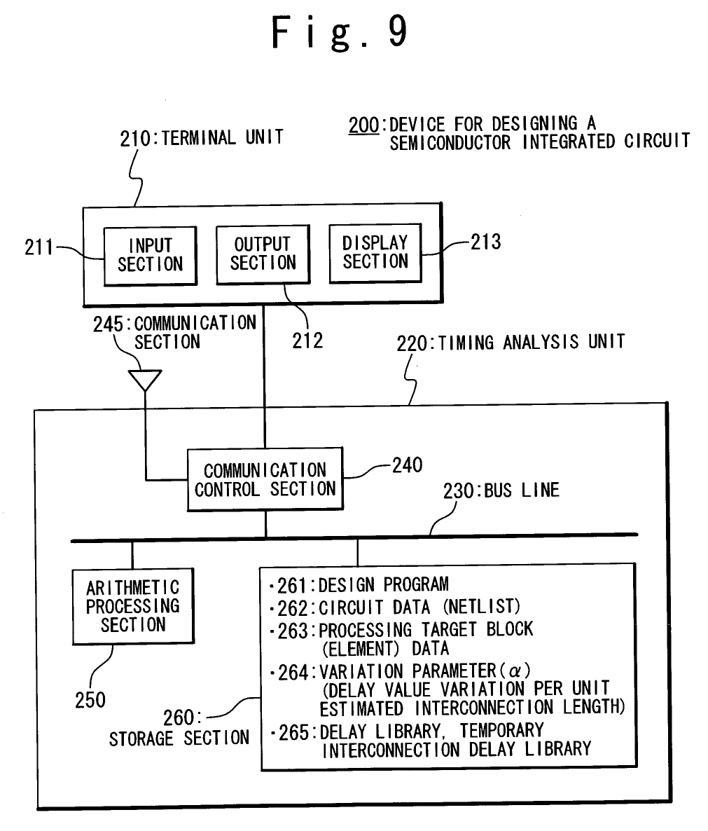

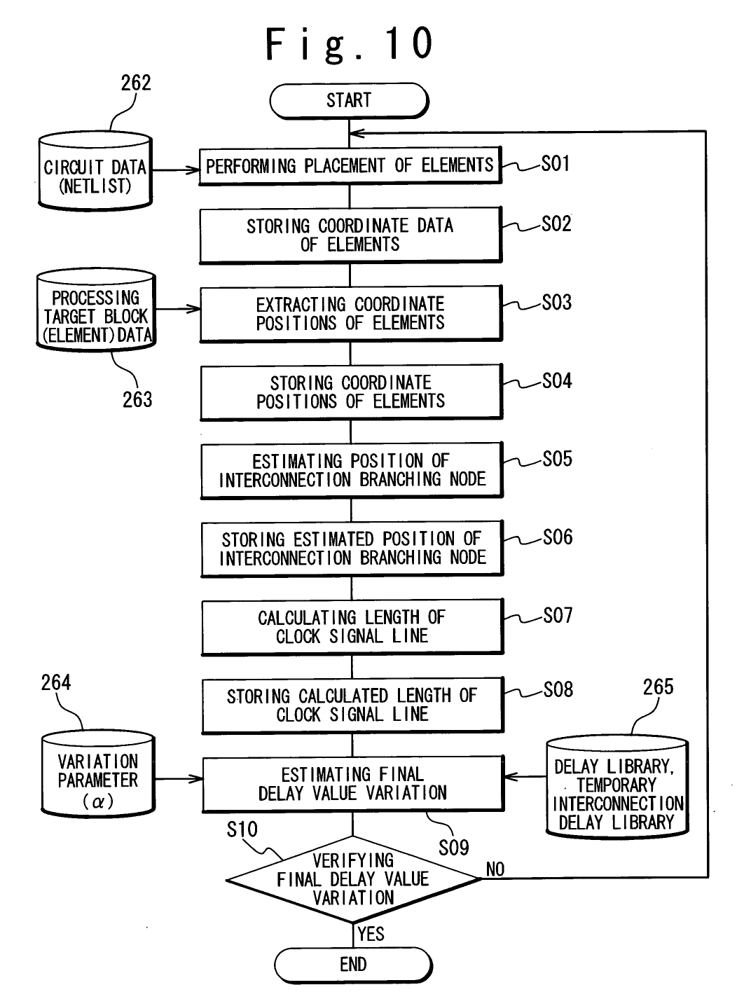

FIG. 9 is the schematic view showing a configuration of a device for designing a semiconductor integrated circuit in the fourth embodiment of the present invention. A device for designing a semiconductor integrated circuit 200 of the present invention includes a timing analysis unit 220 and a terminal unit 210 connected to the timing analysis unit 220. The timing analysis unit 220 is an information-processing device such as a workstation and a personal computer. The terminal unit 210 is an information-processing device such as a personal computer. The timing analysis unit 220 includes an arithmetic processing section 250, a storage section 260, and a communication control section 240, all of which are connected to a bus line 230. The storage section 260 preliminarily stores a design program 261 for designing a semiconductor integrated circuit, circuit data (Netlist) 262 of elements to be arranged in the semiconductor integrated circuit, processing target block (element) data 263, a variation parameter (α) 264, and a delay library 265. The variation parameter 264 includes the delay value variation (α) per unit estimated interconnection length. The delay library 265 includes the temporary interconnection delay library. The communication control section 240 is linked to an external network by wired or wireless connections, and obtains necessary data which are stored in the storage section 260. The communication control section 240 includes a communication section 245 for obtaining the data through the external network, and is further connected to the terminal unit 210. The terminal unit 210 includes an input section 211 for inputting a data to the timing analysis unit 220; an output section 212 for outputting various results calculated in the timing analysis unit 220; and a display section 213 for displaying the above various results.

Next, the method for designing a semiconductor integrated circuit according to the present invention will be described with reference to a drawing. FIG. 10 is a flowchart showing the method for designing a semiconductor integrated circuit (an operation of the device for designing a semiconductor integrated circuit 200) in the fourth embodiment according to the present invention. This flowchart includes an operation for performing timing analysis of a semiconductor integrated circuit based on the method of obtaining the interconnection branching node shown in the first embodiment.

After the device for designing a semiconductor integrated circuit 200 in this embodiment is booted, the arithmetic processing section 250 loads and runs the design program 261 stored in the storage section 260. As mentioned above, the storage section 260 preliminarily stores the design program 261, the circuit data (Netlist) 262 of all the elements arranged in the semiconductor integrated circuit, the processing target block (element) data 263, the variation parameter (α) 264, and the delay library 265. Such data excluding the design program 261, may also be obtained through the terminal unit 210 or the communication section 245 after the program 261 is run.

When the design program 261 is run, circuit data of all the elements placed in the semiconductor integrated circuit under design are read from the circuit data (Netlist) 262 into the arithmetic processing unit 250. Then, based on the read circuit data 262, automatic placement of all the elements arranged on the substrate 100a (shown in FIG. 1) in the semiconductor integrated circuit is performed (step S01), and coordinate data of all the elements on the substrate 100a based on the above placement result is stored in the storage section 260 (step S02). Next, the processing target block data 263 (on the FF 1 and the FF 2), which is the subjects of actual timing analysis, is take into the arithmetic processing section 250, to be matched to the coordinate data of all the elements on the substrate 100a that is stored as mentioned above. Consequently, coordinate positions of the FF 1 and the FF 2 on the substrate 100a, which are the subjects of the actual timing analysis, are extracted (step S03). Then, the coordinate positions of the FF 1 and the FF 2 on the substrate 100a, are stored in the storage section 260 (step S04). Since the coordinate positions of the FF 1 and the FF 2 on the substrate 100a are obtained above, an estimated position of the interconnection branching node A 4 is derived, for example, as explained in the steps S21 to S22 in the first embodiment (step S05). The estimated position of the interconnection branching node A 4 is stored in the storage section 260 (step S06). When it is estimated that a length of the line segment connecting the FF 1 and the FF 2 in FIG. 1 is L, the angle between the vertical line passing through the interconnection branching node A 4 and the line segment connecting the FF 1 and the interconnection branching node A 4 is θ, and the angle between the parallel line passing through the FF 2 and the line segment connecting the FF 2 and the interconnection branching node A 4 is θ, the length of the clock signal line from the estimated position of the interconnection branching node A 4 to each of the FF 1 and the FF 2 is expressed as follows (step S07):
sin θ×(L/2^{0.5})+cos θ×(L/2^{0.5}).
In this mathematical expression, “×” is used as a multiple mark. The value of the length of the clock signal line from the estimated position of the interconnection branching node A 4 to each of the FF 1 and the FF 2 is stored in the storage section 260 (step S08).

To calculate a delay value variation of a clock signal that corresponds to the above length by using the length of the signal line from the estimated position of the interconnection branching node A 4 to each of the FF 1 and the FF 2, it is just necessary to multiply the length by the delay value variation (α) per unit estimated interconnection length. The delay value variation (α) is stored in the storage section 260 in advance as the variation parameter (α) 264, and is preliminarily set in each setting condition of the semiconductor integrated circuit. Therefore, in this embodiment, the delay value variation of the clock signal is expressed as follows:
α×sin θ×(L/2^{0.5})+cos θ×(L/2 ^{0.5}).
In this mathematical expression, “×” is used as a multiple mark.

In the actual timing verification as shown in FIG. 3, the clock signal delay variation amount of in each element of the buffer 7, the buffer 8 and the buffer 9, which are connected to the clock signal input side of the interconnection branching node A 4, the FF 1 and the FF 2, respectively, is also considered. Further, it is also necessary to consider the signal delay variation amount in the combination cell (element) group 5 actually placed between the FF 1 and the FF 2. The clock signal delay variation amount in each element of the buffer 7, the buffer 8, the buffer 9 and the combination cell (element) group 5 is stored in the storage section 260 in advance as the delay library 265. These stored data are taken into the arithmetic processing section 250, to estimate the final delay value variation of the clock signal of the semiconductor integrated circuit (step S09). Next, it is judged whether or not the estimated final delay value variation of the clock signal is within a delay value allowable range of the semiconductor integrated circuit. Based on the judgement criteria mentioned in the first embodiment, the verifications of the setup time and the hold time for synchronous circuits as the analysis subjects, are conducted (step S10).

When it is verified as a result of the verifications, that the delay value variation of the clock signal derived in this embodiment is within the design allowable range of the semiconductor integrated circuit (step S10: YES), the design operation in the process is ended. However, when it is not verified (step S10: NO), a change is made such that the relative positions of the FF 1 and the FF 2 on the substrate 100a get closer for example, based on the examination result.

According to the present embodiment, since the verification is preliminarily performed of the clock variations between target synchronous circuits in particular before the interconnection design is performed, it is possible to avoid re-performing synchronous circuit placement after the interconnection design is performed. Thus, the present invention can provide the device for designing a semiconductor integrated circuit with high design efficiency.

In this embodiment, description is made based on the method of estimating the interconnection branching node in the first embodiment (e.g. S21 and S22). The present invention may be implemented based on the method of estimating the interconnection branching node in the third embodiment (e.g. S41, S42, S43 and S44). Also, in this embodiment, the subjects of the timing analysis are explained based on the synchronous circuit in the first embodiment. The present invention may be implemented based on the general elements in the second embodiment as subjects of the timing analysis.

According to the present invention, it is possible to avoid re-performing element placement after interconnection design is performed, and provide the method and device for designing a semiconductor integrated circuit with high design efficiency. This is realized by preliminarily performing an verification of clock variations especially between target elements, before the interconnection design is performed.

It is apparent that the present invention is not limited to the above embodiment, that may be modified and changed without departing form the scope and spirit of the invention.

What is claimed is:

1. A method for designing a semiconductor integrated circuit comprising:
(a) placing a plurality of elements based on circuit data including data of said plurality of elements to be placed on a semiconductor integrated circuit;
(b) estimating a position of an interconnection branching node at which an interconnection branches off to each of said plurality of elements;
(c) estimating each interconnection length between said interconnection branching node and each of said plurality of elements;
(d) calculating a delay timing variation based on said each interconnection length, wherein said delay timing variation is a variation of an arrival time when a signal travels from said interconnection branching node to each of said plurality of elements; and
(e) verifying whether said delay timing variation is within a design allowable range of said semiconductor integrated circuit.

2. The method for designing a semiconductor integrated circuit according to claim 1, wherein said signal is a clock signal, and
said plurality of elements is a register.

3. The method for designing a semiconductor integrated circuit according to claim 1, wherein said step (b) includes:
(b1) defining a isosceles triangle of which hypotenuse is a line segment connecting between two of said plurality of elements, and
(b2) estimating a position of an apex of said isosceles triangle as said position of said interconnection branching node to said two of said plurality of elements.

4. The method for designing a semiconductor integrated circuit according to claim 1, wherein said step (b) includes:
(b1) dividing an area in which said plurality of elements is placed into a plurality of square regions, wherein two of said plurality of elements are placed in a first and second square regions of said plurality of square regions, respectively, and
(b2) estimating a position of a branching node to said first and second square regions as said position of said interconnection branching node to said two of said plurality of elements, by assuming a H-tree of a clock tree based on said plurality of square regions.

5. The method for designing a semiconductor integrated circuit according to claim 1, wherein said step (d) includes:
(d1) calculating said delay timing variation based on a predetermined delay value variation per unit estimated interconnection length.

6. The method for designing a semiconductor integrated circuit according to claim 1, wherein said step (e) includes:
(e1) verifying whether said each delay timing variation satisfy a criterion of a setup time, and
(e2) verifying whether said each delay timing variation satisfy a criterion of a hold time.

7. A device for designing a semiconductor integrated circuit comprising:
a timing analysis unit configured to includes:
an arithmetic processing section, and
a storage section configured to stores
circuit data including data of a plurality of elements to be placed on a semiconductor integrated circuit; and
a terminal unit configured to be connected to said timing analysis unit and includes a display section displaying an analysis result of said timing analysis unit,
wherein said arithmetic processing section places said plurality of elements based on said circuit data; estimates a position of an interconnection branching node at which an interconnection branches off to each of said plurality of elements; estimates each interconnection length between said interconnection branching node and each of said plurality of elements; calculates a delay timing variation based on said each interconnection length, wherein said delay timing variation is a variation of an arrival time when a signal travels from said interconnection branching node to each of said plurality of elements; and verifies whether said delay timing variation is within a design allowable range of said semiconductor integrated circuit, and
said display section displays a verifying result verified by said arithmetic processing section.

8. The device for designing a semiconductor integrated circuit according to claim 7, wherein said signal is a clock signal, and
said plurality of elements is a register.

9. The device for designing a semiconductor integrated circuit according to claim 7, wherein said arithmetic processing section defines a isosceles triangle of which hypotenuse is a line segment connecting between two of said plurality of elements; and estimates a position of an apex of said isosceles triangle as said position of said interconnection branching node to said two of said plurality of elements.

10. The device for designing a semiconductor integrated circuit according to claim 7, wherein said arithmetic processing section divides an area in which said plurality of elements is placed into a plurality of square regions, wherein two of said plurality of elements are placed in a first and second square regions of said plurality of square regions, respectively; and estimates a position of a branching node to said first and second square regions as said position of said interconnection branching node to said two of said plurality of elements, by assuming a H-tree of a clock tree based on said plurality of square regions.

11. The device for designing a semiconductor integrated circuit according to claim 7, wherein said storage section stores a predetermined delay value variation per unit estimated interconnection length, and
said arithmetic processing section calculates said delay timing variation based on said predetermined delay value variation per unit estimated interconnection length.

12. The device for designing a semiconductor integrated circuit according to claim 7, wherein said arithmetic processing section verifies whether said each delay timing variation satisfy a criterion of a setup time; and verifies whether said each delay timing variation satisfy a criterion of a hold time.

13. The device for designing a semiconductor integrated circuit according to claim 7, wherein timing analysis unit further includes a communication section,
said storage unit further includes a input section, and
said circuit data is supplied from one of said input section and an external network through said communication section.

14. A computer program product of a method for designing a semiconductor integrated circuit, embodied on a computer-readable medium and comprising code that, when executed, causes a computer to perform the following:
(a) placing a plurality of elements based on circuit data including data of said plurality of elements to be placed on a semiconductor integrated circuit;
(b) estimating a position of an interconnection branching node at which an interconnection branches off to each of said plurality of elements;
(c) estimating each interconnection length between said interconnection branching node and each of said plurality of elements;
(d) calculating a delay timing variation based on said each interconnection length, wherein said delay timing variation is a variation of an arrival time when a signal travels from said interconnection branching node to each of said plurality of elements; and
(e) verifying whether said delay timing variation is within a design allowable range of said semiconductor integrated circuit.

15. The computer program product according to claim 14, wherein said signal is a clock signal, and
said plurality of elements is a register.

16. The computer program product according to claim 14, wherein said step (b) includes:
(b1) defining a isosceles triangle of which hypotenuse is a line segment connecting between two of said plurality of elements, and
(b2) estimating a position of an apex of said isosceles triangle as said position of said interconnection branching node to said two of said plurality of elements.

17. The computer program product according to claim 14, wherein said step (b) includes:
(b1) dividing an area in which said plurality of elements is placed into a plurality of square regions, wherein two of said plurality of elements are placed in a first and second square regions of said plurality of square regions, respectively, and
(b2) estimating a position of a branching node to said first and second square regions as said position of said interconnection branching node to said two of said plurality of elements, by assuming a H-tree of a clock tree based on said plurality of square regions.

18. The computer program product according to claim 14, wherein said step (d) includes:
(d1) calculating said delay timing variation based on a predetermined delay value variation per unit estimated interconnection length.

19. The computer program product according to claim 14, wherein said step (e) includes:
(e1) verifying whether said each delay timing variation satisfy a criterion of a setup time, and
(e2) verifying whether said each delay timing variation satisfy a criterion of a hold time.
